(19) United States
(12) Patent Application Publication
(10) Pub. No.: US 2006/0023969 A1
(43) Pub. Date: Feb. 2, 2006

(54) Collaboration and multimedia authoring

(76) Inventors: Eyal de Lara, Toronta (CA); Rajnish Kumar, Atlanta, GA (US); Daniel S. Wallach, Houston, TX (US); Willy Zwaenepoel, Grandvaux (CH)

Correspondence Address: BAKER BOTTS, LLP, 910 LOUISIANA, HOUSTON, TX, 77002-4995, US

(21) Appl. No.: 11/120,010

(22) Filed: May 2, 2005

Related U.S. Application Data
(60) Provisional application No. 60/567,401, filed on Apr. 30, 2004.

(51) Int. Cl. G06K 9/03

(52) U.S. Cl. 382/309

(57) ABSTRACT

The present invention relates generally to the field of computing in resource-poor environments, such as mobile and/or wireless computing systems, and, more particularly, to a system and a method for adaptation-aware editing and/or progressive update propagation that enable authoring multimedia content and/or collaborative work on mobile and/or wireless computing systems and devices. A method for the exchange of a data document between a central data store and a client, the data document including one or more data elements, may be provided. The method may comprise transmitting the data document from the central data store to the client, wherein the transmitted data document received at the client includes data elements having a lower fidelity level as compared with the fidelity level of the data elements stored in the version of the data document at the data store, and modifying one or more data elements of the data document at the client. The method may also comprise identifying that the certain data elements of the data document have been modified by the client, and resolving content conflicts between the content of data elements modified by the client and the content of data elements at the central data store. The method may comprise transmitting the data document from the central data store to the client, wherein the transmitted data document received at the client includes data elements having a lower fidelity level as compared with the fidelity level of the data elements stored in the version of the data document at the data store. The method may also comprise transmitting additional data from the central data store to the client to increase the fidelity level of data elements of the data document received by the client, and resolving any content conflict between the content of data elements modified by the client and the content of the additional data transmitted from the central data stored to the client for the purpose of increasing the fidelity level of data elements of the data document received by the client.

### RELATED APPLICATION

This application claims the benefit of U.S. Provisional Patent Application Ser. No. 60/567,401, filed Apr. 30, 2004, which is herein incorporated by reference in its entirety as if set forth below.

### BACKGROUND OF THE INVENTION

The present invention relates generally to the field of computing in resource-poor environments, such as mobile and/or wireless computing systems, and, more particularly, to a system and a method for adaptation-aware editing and/or progressive update propagation that enable authoring multimedia content and/or collaborative work on mobile and/or wireless computing systems and devices.

Research on mobile computing has made significant progress in adapting applications for viewing multimedia content on mobile devices, as described by Eyal de Lara, Dan S. Wallach, and Willy Zwaenepoel in Puppeteer: Component-based adaptation for mobile computing, in Proceedings of the 3rd USENIX Symposium on Internet Technologies and Systems (USITS), San Francisco, Calif., March 2001; Armando Fox, Steven D. Gribble, Eric A. Brewer, and Elan Amir in Adapting to network and client variability via on-demand dynamic distillation, in SIGPLAN Notices, 31(9):160-170, September 1996; and Brian D. Noble, Mahadev Satyanarayanan, Dushyanth Narayanan, James Eric Tilton, Jason Flinn, and Kevin R. Walker in Agile application-aware adaptation for mobility, in Operating Systems Review (ACM), 51(5):276-287, December 1997, for example. Multimedia authoring and collaborative work on these platforms remain, however, open problems.

Three factors may be identified that hinder multimedia authoring and collaborative work over bandwidth-limited links:

1. Read Adaptations.

The adaptation techniques used to lower resource usage (e.g., energy, bandwidth) may result in situations where content present at the mobile device differs significantly from the versions stored at the server. Typical adaptation techniques adapt by downloading just a fraction of a multimedia document, or by transcoding content into lower-fidelity representations. Naively storing user modifications made to an adapted document may delete elements that were not present at the mobile device, or it may replace high-fidelity data with the transcoded versions sent to the mobile device (even in cases where the user did not modify the transcoded elements).

2. Large Updates.

Mobile users can generate large multimedia content (e.g., photographs, drawings, audio notes) whose propagation may result in large resource expenditures or long upload latencies over a bandwidth-limited link.

3. Conflicts.

The use of optimistic replication models, as described by James J. Kistler and Mahadev Satyanarayanan in Disconnected operation in the Coda file system, in ACM Transactions on Computer Systems, 10(1):3-25, February 1992; and Gerald J. Popek, Richard G. Guy, Thomas W. Page, Jr. and John S. Heidemann in Replication in Ficus distributed file systems in Proceedings of the Workshop on Management of Replicated Data, pages 20-25, Houston, Tex., November 1990, for example, allows concurrent modifications that may conflict with each other. Conflicts can occur in other circumstances as well, but low bandwith and the possibility of frequent disconnection make the occurrence of conflicts more likely.

### SUMMARY

The present invention relates generally to the field of computing in resource-poor environments, such as mobile and/or wireless computing systems, and, more particularly, to a system and a method for adaptation-aware editing and/or progressive update propagation that enable authoring multimedia content and/or collaborative work on mobile and/or wireless computing systems and devices.

A method for the exchange of a data document between a central data store and a client, the data document including one or more data elements, may be provided. The method may comprise transmitting the data document from the central data store to the client, wherein the transmitted data document received at the client includes data elements having a lower fidelity level as compared with the fidelity level of the data elements stored in the version of the data document at the data store, and modifying one or more data elements of the data document at the client. The method may also comprise identifying that the certain data elements of the data document have been modified by the client, and resolving content conflicts between the content of data elements modified by the client and the content of data elements at the central data store. The method may comprise transmitting the data document from the central data store to the client, wherein the transmitted data document received at the client includes data elements having a lower fidelity level as compared with the fidelity level of the data elements stored in the version of the data document at the data store. The method may also comprise transmitting additional data from the central data store to the client to increase the fidelity level of data elements of the data document received by the client, and resolving any content conflict between the content of data elements modified by the client and the content of the additional data transmitted from the central data stored to the client for the purpose of increasing the fidelity level of data elements of the data document received by the client.

The features and advantages of the present invention will be readily apparent to those skilled in the art upon a reading of the description of the embodiments that follows.

### DRAWINGS

The following figures form part of the present specification and are included to further demonstrate certain aspects of the present invention. The present invention may be better understood by reference to one or more of these drawings in combination with the description of embodiments presented herein.

Consequently, a more complete understanding of the present disclosure and advantages thereof may be acquired by referring to the following description taken in conjunction with the accompanying drawings, in which the leftmost significant digit(s) in the reference numerals denote(s) the first figure in which the respective reference numerals appear, wherein:

FIGS. 1A and 1B schematically illustrate state transition diagrams for a pessimistic (A) and an optimistic (B) replication model with support for adaptation-aware editing. Partial-fidelity states and the transitions in and out of these states are represented with gray ovals and dotted arrows, respectively. In contrast, states present in traditional replication models and their transitions are represented with clear ovals and full arrows, respectively;

FIG. 2 schematically illustrates a component split after modifications to a partial-fidelity version;

FIGS. 3A and 3B schematically illustrate pessimistic replication state transition diagrams for components of the client (A) and primary (B) replicas;

FIGS. 4A and 4B schematically illustrate state transition diagrams for individual components of client replicas that support partial document editing and progressive update propagation based on pessimistic (A) and optimistic (B) replication models;

FIG. 5 schematically illustrates a CoFi system architecture;

FIG. 6 schematically illustrates a native data store, CoFi remote and local proxies, and an application that can have versions of the document that differ in their component subsets and fidelities;

FIG. 7 schematically illustrates a latency for sending emails with and without progressive update propagation over 56 Kb/sec;

FIG. 8 schematically illustrates a breakdown of partial update propagation latency while sending emails;

FIG. 9 schematically illustrates a latency for saving modifications to PowerPoint presentations with and without adaptation over 56 Kb/sec;

FIG. 10 schematically illustrates a latency breakdown for upgrading the fidelity of a single image in PowerPoint documents of various sizes;

FIG. 11 schematically illustrates an exemplary embodiment of a method for the exchange of a data document between a central data store and a client, the data document including one or more data elements, according to various illustrative embodiments of the present invention; and

FIG. 12 schematically illustrates an exemplary embodiment of a method for the exchange of a data document between a central data store and a client, the data document including one or more data elements, according to various illustrative embodiments of the present invention.

### DESCRIPTION

The present invention relates generally to the field of computing in resource-poor environments, such as mobile and/or wireless computing systems, and, more particularly, to a system and a method for adaptation-aware editing and/or progressive update propagation that enable authoring multimedia content and/or collaborative work on mobile and/or wireless computing systems and devices.

Illustrative embodiments of the present invention are described in detail below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of the present disclosure.

Various illustrative embodiments described herein introduce adaptation-aware editing and progressive update propagation, two novel mechanisms that enable document authoring and collaborative work over bandwidth-limited links. These mechanisms extend traditional replication models to account for the fidelity level of replicated content. Both mechanisms decompose multimedia documents into their component structure (e.g., pages, images, sounds, video), and keep track of consistency and fidelity at a component granularity. Adaptation-aware editing enables editing adapted documents by differentiating between modifications made by the user and those that result from adaptation. Progressive update propagation reduces the time and the resources required to propagate components created or modified at the bandwidth-limited device by transmitting subsets of the modified components or transcoded versions of those modifications. Adaptation-aware editing and progressive update propagation also reduce the likelihood of update conflicts in at least two ways. First, by working at the component level rather than the whole-document level, they reduce the sharing granularity. Second, because both mechanisms lower the cost to download and upload component data, they encourage more frequent communication, hence increasing the awareness that users have of their collaborators' activities.

By reducing the cost of propagating multimedia content, adaptation-aware editing and progressive update propagation enable new types of applications and extend the reach of existing applications into the mobile realm. The following two examples illustrate the use of both mechanisms:

1. Maintenance.

A work crew inspects damage to a plant caused by an explosion. They use a digital camera to take pictures of the problem area, and send the pictures over a wireless connection to the head office. Since bandwidth is low, and they want an urgent assessment of the seriousness of the situation, they use progressive update propagation to initially send low-resolution versions of the pictures. These initial images allow the head office to determine quickly that there is no need to declare an emergency, but that repair work nonetheless needs to be started immediately. The crew continues to use progressive update propagation to send higher-resolution versions of the pictures, sufficiently detailed to initiate repairs. The head office forwards these pictures to a trusted contractor and to the insurance company. The contractor uses adaptation-aware editing to indicate the suggested repairs on the pictures, and sends the marked-up pictures back to the head office and the insurance company. Both approve the repairs, and the contractor heads out to the site. When the work crew arrives back at the office, full-resolution pictures are saved for later investigation.

2. Collaborative Presentation Design.

A team member on a mobile device takes advantage of adaptation-aware editing to reduce download time by downloading and editing an adapted version of a presentation. The adapted document consists of just a few slides of the original presentation and has low-fidelity images, sounds, and videos. The team member then uses progressive update propagation to share her modifications to the presentation, which include a photograph taken with a digital camera. Progressive update propagation reduces the time for uploading the photograph by sending a low-fidelity version of the image. When the team member reconnects over a high-bandwidth link, the system automatically upgrades the version of the photograph.

The previous scenarios cannot be handled by current conventional adaptation systems that only handle adaptation of read-only content. They also cannot be supported by current conventional replication systems. Propagating transcoded versions of components as described in the above examples, requires the replication model to account for the fidelity level of replicated content. Upgrading the fidelity of an image in a particular version of a document is different from creating a new version with (user) modifications to the document.

As described below, it can be shown that fidelity can be added to a replication protocol independently of the mechanisms used for concurrency control and consistency maintenance. Replication models are typically represented by state diagrams, and the description herein follows this general paradigm. As described below, state diagrams are presented that incorporate the presence of transcoded versions of components, for use with both optimistic and pessimistic replication. The introduction of transcoded component versions is “orthogonal” to the maintenance of consistency between replicas. More specifically, new states are added to represent transcoded versions, but the semantics of the existing states and the transitions between them remain unchanged. Consequently, fidelity can be added readily to any replication protocol, whether optimistic or pessimistic, as would be readily apparent to those of skill in the art having the benefit of the present disclosure.

There are several possible implementations of adaptation-aware editing and progressive update propagation. As described below, various illustrative exemplary prototype implementations of these mechanisms are presented that take advantage of existing run-time application programming interfaces (APIs) and structured document formats. These implementations allow adapting applications for multimedia authoring and collaboration without changing their source code, for example.

These implementations have been demonstrated by experimenting with the Outlook email browser and the PowerPoint presentation software, as described below. Both applications see large reductions in user-perceived latencies. For Outlook, progressive update propagation reduces the time a wireless author has to stay connected to propagate emails with multimedia attachments. For PowerPoint, adaptation-aware editing and progressive update propagation reduce the time that wireless collaborators need to wait to view changes made to the presentation by their colleagues.

Component-based adaptation systems and methods that may be useful in various illustrative embodiments of the present invention are described in U.S. Pat. No. 6,775,671 to de Lara et al., which issued on Aug. 10, 2004, and in pending patent application U.S. Ser. No. 10/914,611, titled “COMPONENT-BASED ADAPTATION SYSTEM AND METHOD,” filed Aug. 9, 2004 for de Lara et al., both of which are hereby incorporated by reference.

### Incorporating Fidelity in Replication Protocols

In this section, a description is given of the implications of extending traditional replication models to provide various degrees of support for adaptation-aware editing and progressive update propagation.

It is possible to decompose documents into their component structure (e.g., pages, images, sounds, video). Component decomposition can be guided by the document's file format, or by a policy set by the content provider or by the client. For example, HTML documents, as well as documents from popular productivity tools use well-defined tags to signal the presence of multimedia elements such as images, sounds, and videos.

Multiple versions of a component can co-exist in different replicas. Two versions of a component may differ because they have different creation times, and, hence, reflect different stages in the development of the component, or because they have different fidelity levels. Two fidelity classes may be considered: full and partial. For a given creation time, a component can have only one full-fidelity version but many partial-fidelity versions. A component is present at full fidelity when its version contains data that is equal to the data when the version was created. Conversely, a component is present with partial fidelity if it has been lossily transcoded from the component's original version. Fidelity is by nature a type-specific notion, and, hence, there can be a type-specific number of different partial-fidelity versions. It is possible to determine whether one version has higher fidelity than another one.

This discussion considers both pessimistic and optimistic replication models. A pessimistic replication model guarantees that at most one replica modifies a component at any given time, and that a replica does not modify a component while it is being read by some other replica. The mutual exclusion guarantee can be realized by various mechanisms, such as locks or invalidation messages. With optimistic replication, replicas may read and write components without any synchronization. A manual or automatic reconciliation procedure resolves conflicts caused by concurrent writes on different replicas.

Replication models are typically represented by state diagrams, and this general paradigm has been followed herein. The states and transitions for a replication model are independent of the specific mechanisms used for consistency maintenance and depend only on whether the replication model is pessimistic or optimistic. The discussion in this section is therefore independent of specific mechanisms used for consistency maintenance, such as invalidations, leases, and/or timeouts. The mechanisms for consistency maintenance only determine what events trigger specific transitions (e.g., transition from Clean to Empty on receiving an invalidation message). This discussion is also independent of the specific mechanisms used to propagate versions between replicas. The use of data or operation shipping, as well as optimizations, such as version diffing, are implementation decisions that do not affect the underlying replication model.

Both primary replica and serverless approaches may be considered. In a primary replica approach, a server holds the primary replica of the document. Clients can replicate subsets or all of the document's components by reading them from the server's primary replica. Client modifications are sent to the server, and there is no direct communication between clients. In contrast, in a serverless configuration there is no centralized server or primary replica and replicas communicate directly.

First, the implications of supporting adaptation-aware editing and progressive update propagation in isolation are described. Then, replication models that support both mechanisms are described. The initial discussion assumes a primary replica. Serverless systems are discussed afterwards.

### Adaptation-Aware Editing

The simplest form of adaptation-aware editing limits users to modifying only components that are loaded with full fidelity at the bandwidth-limited device. Such an implementation requires the replication system to keep track of which components are available at the bandwidth-limited device and whether these components have been transcoded into partial-fidelity versions. This information is normally already present in replication systems or can be easily added. The replication system then prevents users from modifying any component that is not present with full fidelity.

A simple extension to the previous model is to allow users to (completely) overwrite or delete partial-fidelity components or components that were not included in the client's replica subset. In this scenario, the user can (completely) replace the content of a component that was not loaded or that was loaded at partial fidelity with new full-fidelity content generated at the bandwidth-limited device. The user can also remove a component from the document altogether. Adding this functionality does not require keeping an extra state.

### Adaptation-Aware Editing: Pessimistic Replication

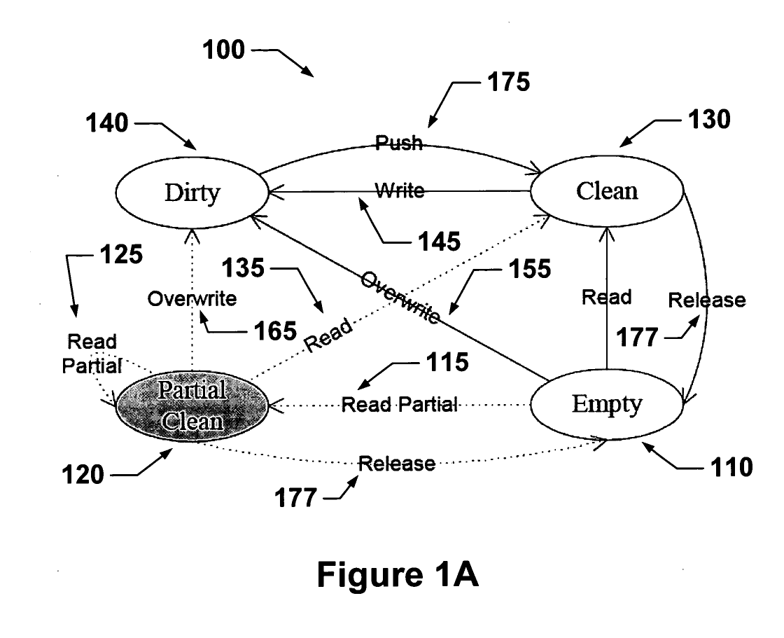

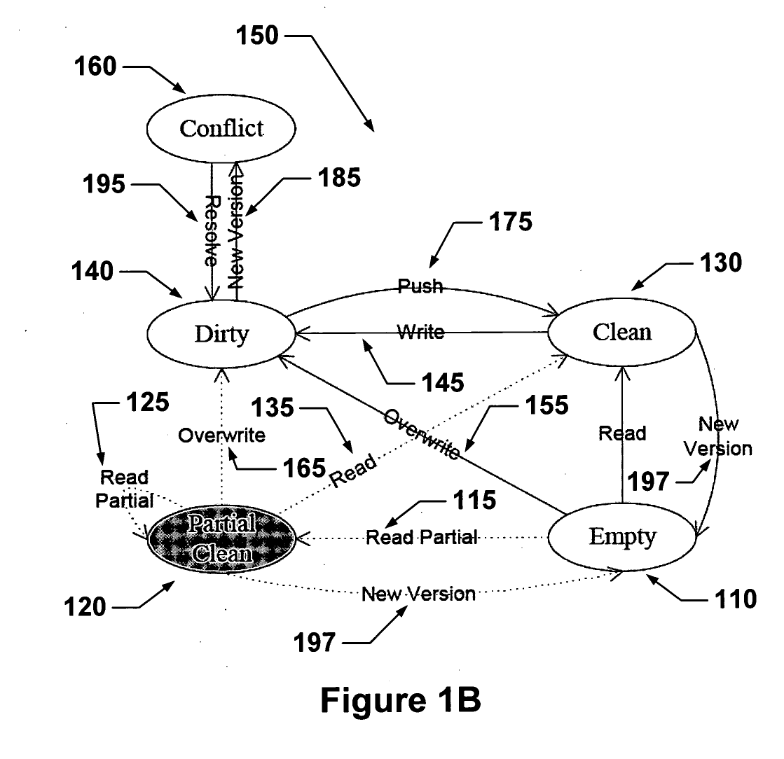

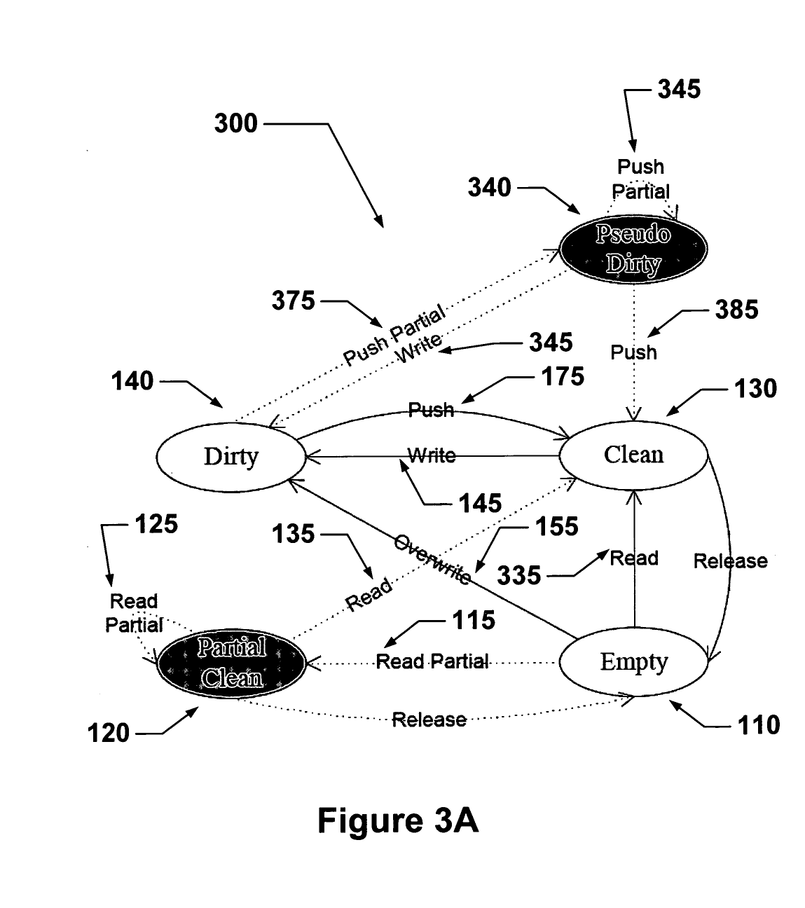

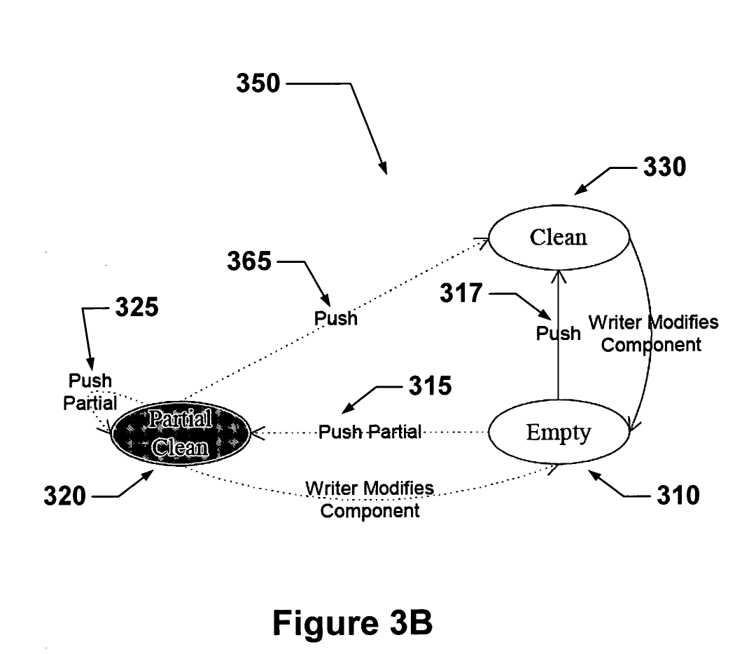

FIG. 1A shows the state transition diagram 100 for individual components of a client replica for a pessimistic replication model that supports modifying full-fidelity component versions and overwriting partial-fidelity component versions. In the state diagrams, new partial-fidelity states are represented by gray ovals and the new transitions in and out of these states by dotted arrows. By way of contrast, the states present in traditional replication models are represented by clear ovals and their transitions by full arrows. The state diagram for the primary replica (not shown) stays the same as without support for adaptation-aware editing. This diagram contains two states, Empty and Clean, with the obvious meanings, similar to the clear ovals and full arrow transitions shown in FIG. 3B, as described below.

In the client replica state transition diagram 100, a component can be in one of four states: Empty 110, Partial-Clean 120, Clean 130, and Dirty 140. A component is in Empty 110 when it is being edited by some other client replica (not shown) or when the client chooses not to read it. A component transitions into Partial-Clean 120 when the client replica reads a partial-fidelity version, as indicated at 115. This version can be further refined by reading higher-fidelity partial-fidelity versions (i.e., Read-Partial), as indicated at 125, or the component can transition into Clean 130 by reading a full-fidelity version, as indicated at 135. The component transitions into Dirty 140 when the client replica either modifies a full-fidelity version (i.e., component in Clean 130 state), as indicated at 145, or overwrites an unloaded component, as indicated at 155, or a partial-fidelity version, as indicated at 165 (i.e., a component in Empty 110 or Partial-Clean 120, respectively). The component transitions back to Clean 130 when the client replica propagates a full-fidelity version to the primary replica, as indicated at 175. Finally, a component transitions back to Empty 110 when the client replica no longer wishes to read the component, as indicated at 177. Transitions to Empty 110 depend on the specific mechanisms used to guarantee mutual exclusion, and can occur, for example, when the client replica releases a lock or receives an invalidation.

### Adaptation-Aware Editing: Optimistic Replication

FIG. 1B shows the state transition diagram 150 for an optimistic replication model. The optimistic replication diagram 150 differs from the pessimistic diagram 100 (FIG. 1A) in two ways: First, it has an extra Conflict 160 state for conflict resolution. The component transitions to the Conflict 160 state when the replica detects the primary replica version and the client replica version are concurrent (i.e., it is not possible to determine a partial ordering for the two versions), as indicated at 185. The component transitions back to the Dirty 140 state once the client replica reads the conflicting version and resolves the conflict, as indicated at 195. Second, transitions from the Clean 130 and Partial-Clean 120 states to the Empty 110 state occur when the client replica learns that the primary replica has a more recent version for the component, as indicated at 197. The decision of when to transition to Empty 110 is left to the implementation. Some implementations may eagerly invalidate the current version, while others may allow the user to keep working with the current version. In other words, it is the implementation's responsibility to decide how eagerly it wants to act on the consistency information it receives.

### Adaptation-Aware Editing: Modification of Partially-Loaded Components

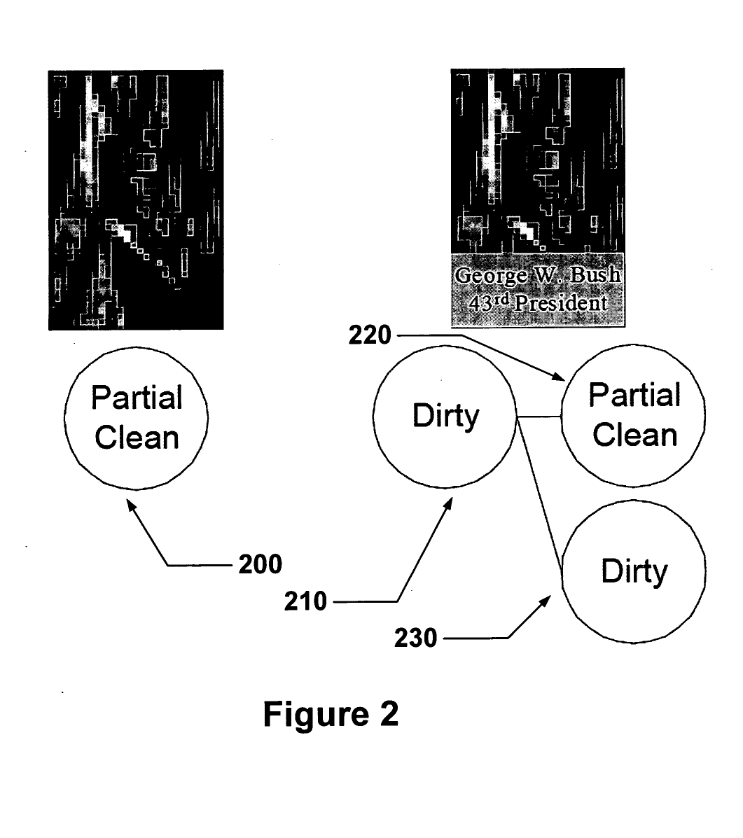

A more ambitious form of adaptation-aware editing allows users to modify just a portion of a partial-fidelity version, for example, to replace parts of transcoded images, audio recordings, or video streams. Such modifications result in a component version that contains a mixture of partial- and full-fidelity data, which contravenes the initial assumption that the replication system keeps track of fidelity at the component granularity. While the semantics of some data types, such as images, may support modifications to just parts of the component's version, these semantics are not visible to the replication system. To reflect the changes to the replication system, the component 200 may be split into two subcomponents 220 and 230, as indicated at 210 and as shown in FIG. 2, for example. The first subcomponent 220 holds the partial-fidelity data, which was not modified by the user, and the second subcomponent 230 holds the full-fidelity modifications made by the user. The original component 200 (now turned into the container 210 for the two subcomponents 220 and 230) transitions to the Dirty 140 state, to reflect the change in the document's component structure. The subcomponent 220 holding unmodified partial fidelity data remains in the Partial-Clean 120 state. In contrast, the subcomponent 230 holding new full-fidelity data transitions to the Dirty 140 state.

A partial-fidelity version can also be changed by an operation \hat{B}ₒₚ that does not produce any full-fidelity data, for instance, by applying a gray-scale filter to a partial-fidelity image. For these cases, the operation \hat{B}ₒₚ rather than the resulting data has to be propagated to the primary replica, and applied there. After the operation \hat{B}ₒₚ has been propagated and applied to the server's version, the client's version transitions into Partial-Clean 120 if the client's version can be lossily transcoded from the server's version, and to Empty 110 otherwise. In other words, the client's version transitions to Partial-Clean 120 only if the lossy transcoding algorithm Âₒₚ used to derive the client's version and the operation \hat{B}ₒₚ being propagated are commutative, such that [Âₒₚ, \hat{B}ₒₚ]=0=Âₒₚ\hat{B}ₒₚ−\hat{B}ₒₚÂₒₚ.

In either of the above cases, reflecting the modifications made to the partial-fidelity version on the full-fidelity version available at the server may require data-type specific instrumentation (i.e., code that knows how to extract the modifications to a partial-fidelity version, and merge them with the full-fidelity version at the server).

### Progressive Update Propagation

A replication system supports progressive update propagation by propagating a subset of the modified components and/or by propagating partial-fidelity versions of modified components.

In this section, the implications are considered of an implementation that supports progressive update propagation but does not support transcoding components on read or editing partial-fidelity components. In such an implementation, client replicas have by default full-fidelity versions of the components they replicate. A client replica has a partial-fidelity version for a component only when the component is being updated by some other client and the updates are being progressively propagated. In other words, the decision to propagate partial-fidelity data is made by the replica that is writing the component and not by the reader, as was the case in the previous section describing Adaptation-Aware Editing. Moreover, independently of whether a pessimistic or an optimistic approach to replication is implemented, once a partial-fidelity version has been propagated to the primary replica, it can only be replaced with another version created by the same writer (i.e., a higher-fidelity version or a more recent version). Replacing a partial-fidelity version with a version created by a different writer would require editing partial-fidelity components, which is not allowed by the implementation discussed in this section. In the section below on Combining Adaptation-Aware Editing and Progressive Update Propagation, an implementation is described that allows a writer to replace a partial-fidelity version created by another writer.

### Progressive Update Propagation: Pessimistic Replication

Supporting progressive update propagation requires adding one new state to the primary replica's state transition diagram 350 (Partial-Clean 320), as shown in FIG. 3B, and two new states to the client replica's state transition diagram 300 (Pseudo-Dirty 340 and Partial-Clean 120), as shown in FIG. 3A.

FIGS. 3A and 3B show the state transition diagrams 300 and 350 for an individual component in a pessimistic replication model at a client replica and at the primary replica, respectively. The transition diagram 350 for the primary replica is simple, as shown in FIG. 3B. A component at the primary replica can be in one of three states: Empty 310, Partial-Clean 320, and Clean 330. A component is in the Empty 310 state while it is being edited by a client replica. The component transitions to the Partial-Clean 320 and Clean 330 states when the writer pushes a partial-fidelity version, as indicated at 315, or a full-fidelity version, as indicated at 317, of the components, respectively. The partial-fidelity version can be further refined by pushing higher-fidelity partial-fidelity versions (i.e., Push-Partial) of the component, as indicated at 325.

A component in a client replica can be in one of five states: Empty 110, Clean 130, Partial-Clean 120, Dirty 140, and Pseudo-Dirty 340. A component is in the Empty 110 state either while it is being modified by some other client replica or when the client has chosen not to read it. A component transitions to Clean 130 by reading a full-fidelity version, as indicated at 335. If only a partial-fidelity version is available at the primary replica because the last writer has not propagated a full-fidelity version yet, the client replica can read this partial-fidelity version and transition to Partial-Clean 120, as indicated at 115. The component transitions from Clean 130 to Dirty 140 after the client modifies its content, as indicated at 145. The client can then propagate modifications to the primary replica in two ways. First, the writer can push a full-fidelity version of the modifications, as indicated at 317 and 175, forcing the component at the primary and writer's replica to transition to Clean 330 and Clean 130, respectively. Second, the writer can propagate a partial-fidelity version of the component, forcing the component to transition to Partial-Clean 320 in the primary replica, as indicated at 315, and to Pseudo-Dirty 340 in the writer's replica, as indicated at 375. The various replicas remain in these states until the writer pushes a full-fidelity version, as indicated at 365 and 385, and the component at both the primary and writer's replica transitions to Clean 330 and Clean 130, respectively. At this time, other client replicas can read the full-fidelity version and transition to Clean 130. Alternatively, a writer in Pseudo-Dirty 340 can modify the component for a second time and transition to Dirty 140, as indicated at 345. If other replicas are to obtain access to a partial-fidelity version, it is imperative that the writer relinquishes exclusive access rights. This enables other replicas to read the partial-fidelity version, but requires the replica in Pseudo-Dirty 340 to re-acquire exclusive access to the component before it can modify it again and transition to Dirty 140, as indicated at 345.

### Progressive Update Propagation: Optimistic Replication

In an optimistic replication scheme, before propagating modifications to a component, the writer has to determine if his modifications conflict with other modifications previously reflected at the primary replica. If there is a conflict, the client replica has to resolve it by merging (in a type-specific way) the full-fidelity versions of the conflicting modifications. After resolution, the client replica can propagate a full-fidelity version or a partial-fidelity version of the component to the primary replica. If, however, the primary replica has only a partial-fidelity version for a conflicting component (i.e., the concurrent writer has not propagated a full-fidelity version of its modifications), the two versions cannot be merged as this would violate the restriction on editing partially-loaded components. In this case, conflict resolution has to be delayed until the client replica, which propagated the conflicting partial-fidelity version, propagates a full-fidelity version of its modifications. This problem demonstrates the limitations of implementing partial update propagation for optimistic concurrency control in the absence of adaptation-aware editing. The next section describes how to implement this combination.

### Combining Adaptation-Aware Editing and Progressive Update Propagation

In this section the implications are explored of extending pessimistic and optimistic replication models to support both partial document editing and progressive update propagation. Replication systems are considered that support all the features presented and described above in the sections on Adaptation-Aware Editing and Progressive Update Propagation.

### Combining Adaptation-Aware Editing and Progressive Update Propagation: Pessimistic Replication

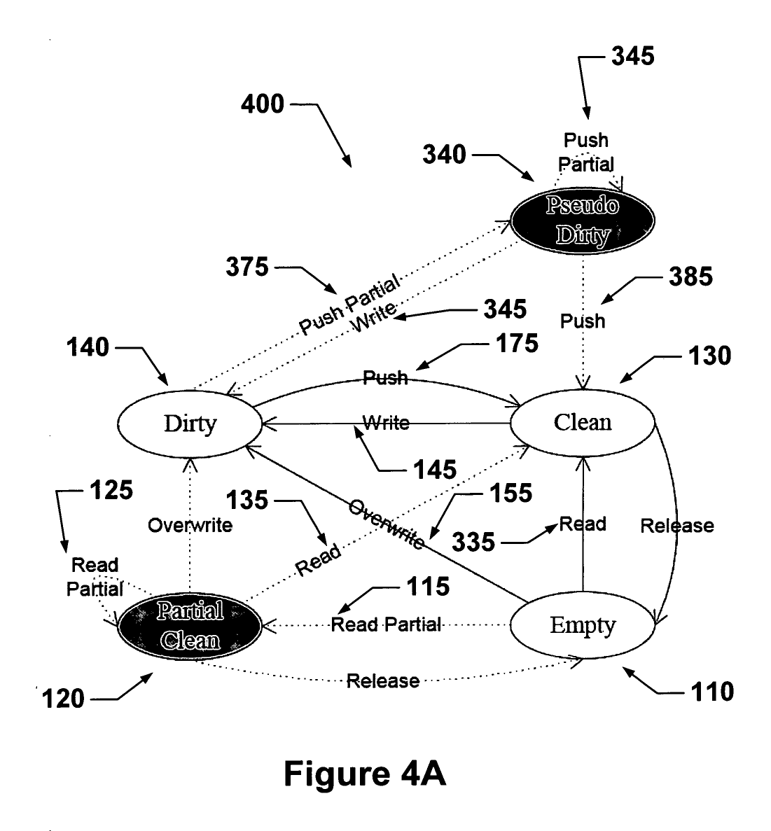

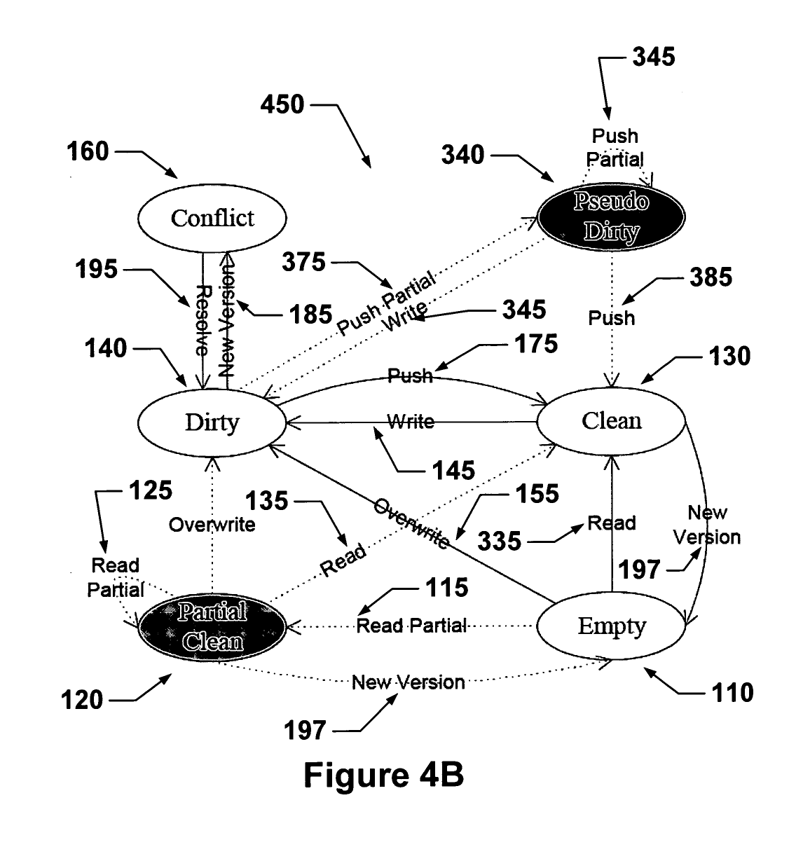

FIG. 4A shows the state transition diagram 400 for components at the client replica for a pessimistic replication system that supports adaptation-aware editing and progressive update propagation. The state transition diagram for components at the primary replica may be the same as the state transition diagram 350, as shown in FIG. 3B, for example.

The state transition diagram 400 in FIG. 4A is similar to the state transition diagram 300 of FIG. 3A and most states have similar semantics. The semantics of Partial-Clean 120 and Pseudo-Dirty 340 are, however, a little different. A component may be in the Partial-Clean 120 state because the client requested a partial-fidelity version to reduce its network usage, or because only a partial-fidelity version of the component is available at the primary replica. As was the case in the section above on Progressive Update Propagation: Pessimistic Replication, if other replicas are to obtain access to a partial-fidelity version, it is imperative that the writer relinquishes exclusive access rights. Moreover, if another replica is to replace the partial-fidelity version with a later version with new data, the current writer should relinquish all access.

Because adaptation-aware editing is supported, a second client replica can read and modify a component as soon as a partial-fidelity version is available at the primary replica. Two scenarios are possible. First, the second client replica can delete or completely overwrite the component. In this case, the second writer propagates the new version of the component to the primary replica (in either full or partial fidelity), where it supersedes all previous versions, including any version propagated by the first writer. Based on the implementation, any further versions propagated by the first writer are either stored for archival purposes or discarded. Second, the second client replica modifies just a portion of the component. As was the case in the section above on Adaptation-Aware Editing: Modification of Partially-Loaded Components, propagating the modifications to the partial-fidelity version requires data-type specific instrumentation. This instrumentation may or may not require waiting for the first writer to propagate a full-fidelity version of its modifications. Alternatively, for some data types it may be possible to propagate the second writer's modifications to the primary replica, and merge them lazily with the first writer's modification as they arrive.

### Combining Adaptation-Aware Editing and Progressive Update Propagation: Optimistic Replication

FIG. 4B shows the state transition diagram 450 for an optimistic replication model that supports partial document editing and progressive update propagation. The state transition diagram 450 is similar to the state transition diagram 400 of the pessimistic replication model discussed in the section above on Combining Adaptation-Aware Editing and Progressive Update Propagation: Pessimistic Replication, with states and transitions with the same names having equivalent semantics. The optimistic replication state transition diagram 450 differs in two ways: First, the optimistic replication state transition diagram 450 has an extra Conflict 160 state for conflict resolution. Second, the optimistic replication state transition diagram 450 transitions from Clean 130 and Partial-Clean 120 to Empty 110 and from Dirty 140 to Conflict 160 when the client replica learns about a more recent or concurrent component version, as indicated at 197 and 185, respectively. As was the case in the section above on Adaptation-Aware Editing: Optimistic Replication, the eagerness with which the transitions to the Empty 110 state are taken may be an implementation decision.

Supporting both adaptation-aware editing and progressive update propagation, also enables client replicas to resolve conflicts even when the server's primary-replica just has a partial-fidelity version for the component. In such a case, the client replica reads the conflicting partial-fidelity version, resolves the conflict, and chooses whether to propagate a full-fidelity version or a partial-fidelity version of the modifications. Resolving conflicts using partial-fidelity versions may require data-type specific functionality similar to that described above in the section on Adaptation-Aware Editing: Modification of Partially-Loaded Components for reflecting modifications made to partial-fidelity versions.

### Serverless Replication

The earlier state transition diagrams 100, 150, 300, 350, 400, and 450 can be carried over from a primary replica configuration to a serverless configuration without any change. In a serverless configuration, when a replica modifies a component, that replica becomes the source for distributing these modifications to other replicas. In practice, however, not all replicas have to read the modifications directly from the source replica and replicas can get these modifications from some other replica that in turn got the modifications from the source replica.

Independently of how the modifications are propagated, the last writer has a full-fidelity version of the component and is perceived by other replicas as the source for this version. Hence, the replica that writes the component last becomes effectively a temporary “primary replica” for the component that the replica that writes the component last modified. The states and state transitions otherwise remain the same. If a replica wants to progressively read the component from the primary replica, it needs to maintain a Partial-Clean 120 state. If the temporary primary replica for a particular component wishes to progressively propagate its modifications (i.e., in a push-based implementation), it needs to maintain a Pseudo-Dirty 340 state. If it wants to update more than one replica concurrently, it needs to maintain the progress of each individual transmission as part of that state.

### Summary: Adaptation-Aware Editing and/or Progressive Update Propagation: Optimistic Replication

The changes necessary to the state diagrams for pessimistic and optimistic replication models in order to support adaptation-aware editing and progressive update propagation have been described. In general, the changes involve adding states and transitions. The existing states and transitions remain with their original semantics. Some complications arise if modifications to partial-fidelity versions are allowed, requiring components to be split to reflect old partial-fidelity data and new full-fidelity data. Additionally, data-type specific instrumentation may be required to extract the modifications and reflect them on the full-fidelity version.

### CoFi Prototypes

This section describes CoFi, a prototype implementation of adaptation-aware editing and progressive update propagation. The prototype has been named CoFi because it keeps track of both consistency and fidelity. First, CoFi's system architecture is discuss below. Then, an illustrative embodiment is presented of an optimistic primary replica implementation of adaptation-aware editing and progressive update propagation, as described, for example, in the section above on Combining Adaptation-Aware Editing and Progressive Update Propagation: Optimistic Replication.

### CoFi System Architecture

CoFi adapts applications for collaborative and multimedia authoring over bandwidth-limited networks without modifying their source code or the data repositories. CoFi follows the philosophy introduced in Puppeteer for read-only adaptation, as described in U.S. Pat. No. 6,775,671 to de Lara et al., which issued on Aug. 10, 2004, and in pending patent application U.S. Ser. No. 10/914,611, titled “COMPONENT-BASED ADAPTATION SYSTEM AND METHOD,” filed Aug. 9, 2004 for de Lara et al., both of which have been previously incorporated by reference, which take advantage of the exposed runtime application programming interfaces (APIs) and structured document formats of modem applications.

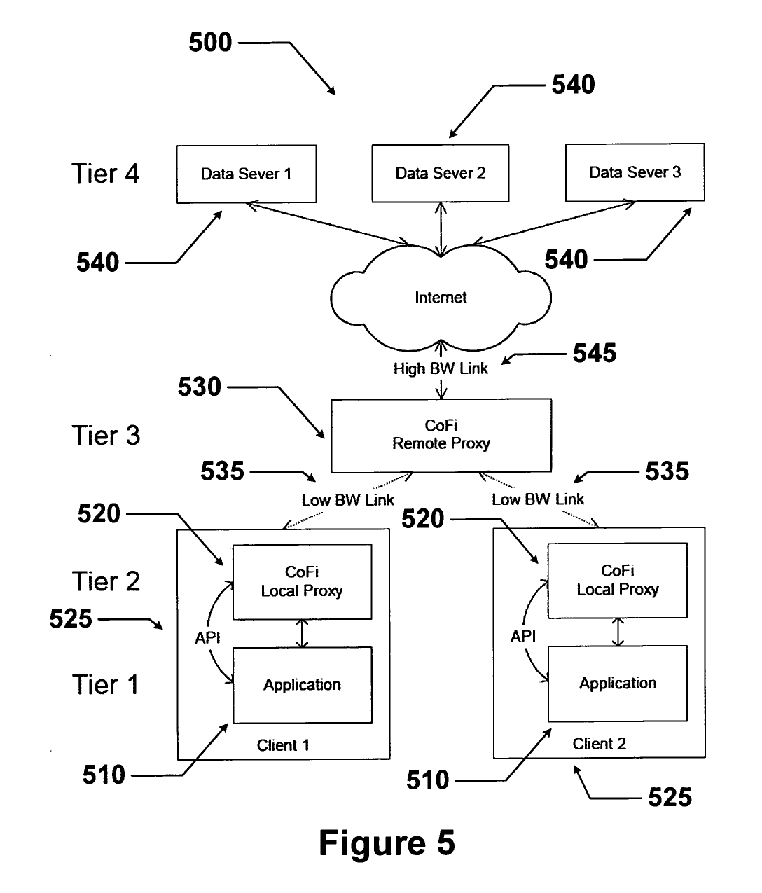

FIG. 5 shows the four-tier CoFi system architecture 500. The four-tier CoFi system architecture 500 comprises the application(s) 510, at least one local proxy 520 and a remote proxy 530, and the data server(s) 540. The application(s) 510 and the data server(s) 540 are completely unaware of CoFi. The data server(s) 540 can be arbitrary repositories of data such as Web servers, file servers, and/or databases, and the like. All communication between the application(s) 510 and the data server(s) 540 goes through the CoFi local and remote proxies 520, 530 that work together to implement adaptation-aware editing and progressive update propagation. The CoFi local proxy 520 runs on the bandwidth-limited device 525 and manipulates the running application 510 through a subset of the exported API of the application 510. The CoFi local proxy 520 is also in charge of acquiring user modifications, transcoding component versions, and running the adaptation policies that control the download and upload of component versions. The CoFi remote proxy 530 runs on the other side of the bandwidth-limited link 535 and is assumed to have high-bandwidth and low-latency connectivity 545 (relative to the bandwidth-limited device) to the data server(s) 540. The CoFi remote proxy 530 is responsible for interacting with the native store and transcoding component versions. Because the application(s) 510 differ in their file formats and run-time APIs, the CoFi proxies 520, 530 rely on component-specific drivers to parse documents and uncover their component structure, to detect user modifications, and to interact with the run-time API of the application(s) 510.

CoFi supports subsetting and versioning adaptation policies. Subsetting policies communicate a subset of the elements of a document, for example, the first page. Versioning policies transmit a less resource-intensive version of some of the components of a document, for example, a low-fidelity version of an image. CoFi adapts the application(s) 510 by extracting subsets and versions from documents. CoFi uses the exported APIs of the application(s) 510 to incrementally increase the subset of the document or improve the fidelity of the version of the components available to the application(s) 510. For example, CoFi may use the exported APIs to insert additional pages and/or higher-fidelity images into the application(s) 510.

### CoFi Optimistic Primary Replica Replication

CoFi implements an optimistic primary replica replication model as described in the section above on Combining Adaptation-Aware Editing and Progressive Update Propagation: Optimistic Replication. The prototype comprises a group of bandwidth-limited nodes, each running a CoFi local proxy, that collaborate by exchanging component data over a single CoFi remote proxy, which stores the primary replica of the document. When a document is first opened, it is imported from its native data store into the CoFi remote proxy. Further accesses to the document, both reads and writes, are then served from the CoFi remote proxy's version. In a more complete implementation, there would be multiple remote proxies communicating between each other, but this communication can be implemented by methods known to those of skill in the art having the benefit of the present disclosure, and the current prototype allows a focus on more novel aspects of CoFi. To enable communication with non-CoFi-enabled programs, CoFi exports document modifications back to their native data store.

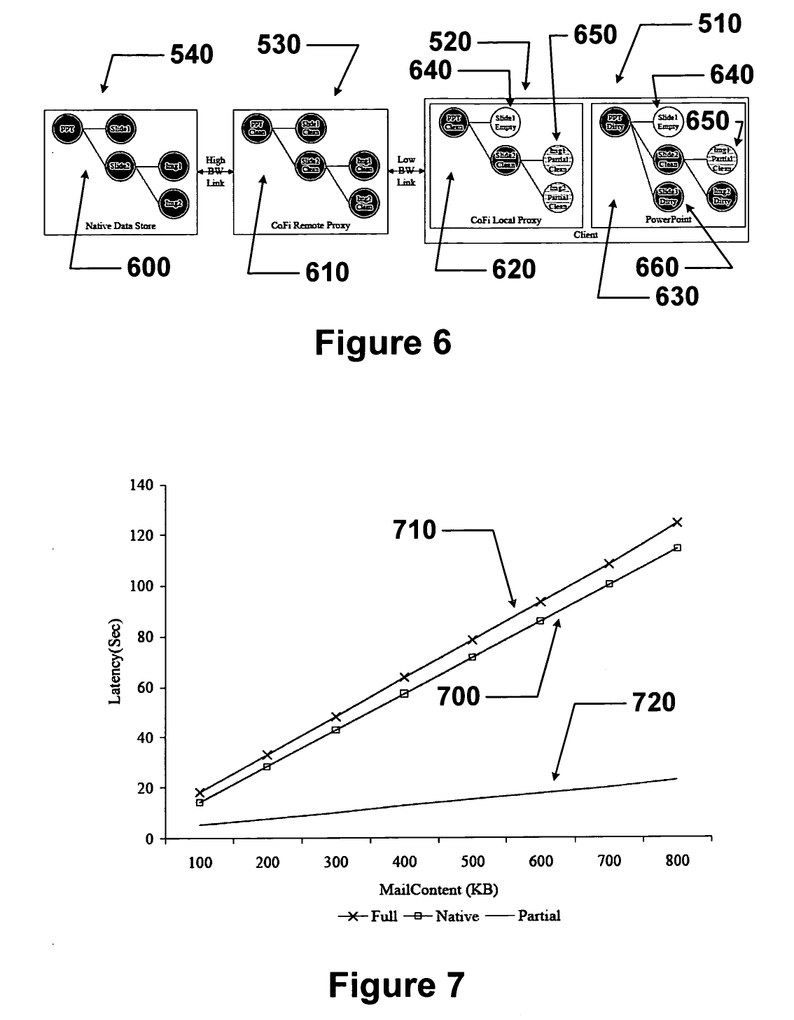

In CoFi, several versions of a document co-exist in various parts of the system. FIG. 6 exemplifies the state of the system for a single client editing a PowerPoint document. FIG. 6 shows that there is one version of the document in each of the native data store 540, the CoFi remote proxy 530 and the CoFi local proxy 520, and the application 510. Moreover, FIG. 6 shows that these versions differ in their component subsets and component fidelities. In the example, the native data store 540 and the CoFi remote proxy 530 have complete versions 600 and 610, respectively, of the document. In contrast, both the CoFi local proxy 520 and the application 510 have just incomplete versions 620 and 630, respectively: the first slide 640 is empty and the images of the second slide 650 are only present in partial fidelity. Finally, the application 510 version has an extra slide component 660.

The differences between the versions in the remote and local proxy result from subsetting and versioning adaptations. In contrast, the differences between the versions in the local proxy and the application result from user modifications. The native store and remote proxy versions can differ because the two versions have not been synchronized (i.e., modifications have not been propagated to the native store), or when the native store version is being updated using out-of-band mechanisms (i.e., outside of the CoFi system).

Below is described how versions of the document converge by exchanging component data. First, how CoFi propagates user modifications from the bandwidth-limited device to the CoFi remote proxy and the data store is described. Second, how the CoFi local proxy refreshes the application's document version with newer or higher-fidelity component versions is described.

### CoFi Optimistic Primary Replica Replication: User Modification Propagation

Adaptation policies running on the CoFi local proxy 520 (as described in the section above on CoFi System Architecture) control the propagation of user modifications to the CoFi remote proxy 530. Update propagation involves four stages: acquiring user modifications, resolving conflicts, transmitting modifications to the remote proxy 530, and synchronizing the modifications with the document's native store 540.

Acquire Modifications

CoFi acquires user modifications by comparing the local proxy's 530 document version to the application's 510 version. Preferably, CoFi would use the application's exported API to acquire any user modifications. When such functionality is not provided by the application's 510 API, CoFi may instruct the application 510 to save a temporal version of the document in the local file system. CoFi then parses the temporary document and compares it to the local proxy 520 version.

Conflict Resolution

CoFi detects conflicting modifications by tagging component versions with version numbers, which determine the partial order of modifications in the system. CoFi implements both client-based and server-based conflict resolution. In client-based resolution, the local proxy 520 fetches the conflicting version from the remote proxy 530, resolves the conflict and creates a new version that dominates the two conflicting versions. In server-based resolution, the client pushes its version to the remote proxy 530, and a resolver executing in the remote proxy 530 creates a new version that merges the conflicting modifications.

When user intervention is necessary to resolve a conflict, conflict resolution is client-based. To facilitate conflict resolution, the application-specific resolution policy can use the application's 510 exported API to present the conflicting component versions in the context of the application's 510 environment.

Modification Transmission

A policy running on the local proxy 520 selects the subset of components for which to propagate modifications, as well as the fidelity level for each component in the subset. The policy can later increase the fidelity level of a previously propagated component by re-selecting the component and pushing a higher-fidelity version.

Synchronization with Native Storage

CoFi's remote proxy 530 exports documents to their native storage 540 to enable information sharing with clients outside of the CoFi system and to leverage the mechanisms that these storage systems may implement (e.g., availability, fault tolerance, security, and the like). Before exporting modifications, CoFi needs to detect if the native store 540 has been modified by an application outside of CoFi's control. CoFi detects and resolves conflicts created by out-of-band modifications using similar mechanisms to those explained above (i.e., by comparing the last-known and current states of the native store 540).

### CoFi Optimistic Primary Replica Replication: Refreshing the Application's Version

Adaptation policies can refresh the application's 510 document version to reflect changes made by other users and/or to increase the fidelity of a component present at partial fidelity. This process involves three steps: fetching newer or higher-fidelity versions, detecting any user modifications to the components about to be updated, and using the application's 510 API to update the application's 510 document version. If the update process detects that the components have been modified by the user, then a conflict has occurred and the modifications have to be merged with the new version fetched from the remote proxy 530 in a component-specific way, following the techniques for conflict resolution described above in the section on CoFi Optimistic Primary Replica Replication: User Modification Propagation, for example.

### CoFi Implementation Details CoFi Implementation Details: User Interaction with CoFi

In the current prototype, the applications' toolbars are extended with extra fields for selecting an adaptation policy that determines the fidelity level at which a document is opened or saved. Optionally, CoFi could rely on monitoring of bandwidth or other resources to automatically choose a particular fidelity level.

CoFi also provides a Component Viewer window that shows the current state of components in a document. Using this window, users can determine what components are currently loaded in the application, what components are in progress of being loaded, whether modifications to a component have been propagated to the remote proxy and with what fidelity, whether a newer version of a component is known to be available at the remote proxy, and whether a conflict has been detected for any component. Users can also interact with the Component Viewer to control the propagation of component versions.

### CoFi Implementation Details: Client-Server Interactions

The current prototype implementation is client-driven. That is, clients specify when they want to read or write a document and at what fidelity. The client also indicates when it wants to get or send a refinement of an earlier transcoded version. The server does not notify the clients of new versions or new refinements. Such a facility could be added through a callback mechanism, but would leave other aspects of the implementation unchanged.

### CoFi Implementation Details: Relationship to Puppeteer

CoFi shares some of the code base of Puppeteer, as described in U.S. Pat. No. 6,775,671 to de Lara et al., which issued on Aug. 10, 2004, and in pending patent application U.S. Ser. No. 10/914,611, titled “COMPONENT-BASED ADAPTATION SYSTEM AND METHOD,” filed August 9, 2004 for de Lara et al., both of which have been previously incorporated by reference, namely the code to parse document formats, some of the code in the local proxy to interact with the application, and the protocol to interact between the local and remote proxies.

### Experimental Results

In this section, results of experiences using CoFi to add adaptation-aware editing and progressive update propagation to the Outlook email client and the PowerPoint presentation system are described. Progressive update propagation has been implemented for both applications. Adaptation-aware editing has also been supported for PowerPoint. The CoFi drivers and policies implemented for Outlook and PowerPoint consist of 2,365 and 3,315 lines of Java code, respectively.

The performance of CoFi was measured on an experimental platform consisting of three 500 MHz Pentium III machines running Windows 2000. Two of the machines are configured as clients and one as a server. Client machines run the user application and the CoFi local proxy. The server machine runs the CoFi remote proxy. Clients and the CoFi server communicate via a fourth PC running the DummyNet network simulator. This setup allows control of the bandwidth between clients and server to emulate various network technologies. The departmental NFS and IMAP servers were used as the native stores for the experiments with PowerPoint and Outlook, respectively.

### Experimental Results: Outlook

An email service that supports the progressive propagation of images embedded in or attached to emails was developed. On the sender side, the progressive email services use Outlook's email client to generate emails. On the receiving end, both CoFi-enabled clients running Outlook and standard third-party email readers were supported.

Emails were implemented as CoFi shared documents that are written only by the email's sender but are read by one or more recipients. The sender adaptation policy propagates the text content of new emails, transcodes images into a progressive JPEG representation and sends only portions of an image's data. The sender can propagate fidelity refinements for images by selecting the email from a special Outlook folder. and re-sending it. The image fidelity refinements are available to CoFi-enabled recipients as soon as they reach the CoFi remote proxy. For CoFi-enabled recipients, the adaptation policy fetches the email's text content and transcoded versions of its image attachments. Readers request fidelity refinements by clicking a refresh button added on Outlook's toolbar. Finally, third-party email readers are supported by composing a new email message once all images have reached full fidelity.

### Experimental Results: Outlook—Progressive Update Propagation

FIG. 7 plots the latencies for transmitting a set of synthetic emails consisting of a few text paragraphs and a variable number of image attachments each of size 100 KB over a 56 Kbps link. The plots show results for a run that uses Outlook without any adaptation support (Native) 700, and two CoFi runs, one that sends the full images (Full) 710, and a second that uses versioning to propagate partial-fidelity versions of the images (Partial) 720. In this experiment, a partial-fidelity version correspond to the initial 1/7 of the content of an image encoded in a progressive JPEG representation.

For the Native run 700, only the time it takes to transmit the emails between the mobile client running Outlook and an SMTP server on the other end of the bandwidth-limited link is measured. This accounts for the time that the mobile client has to wait before disconnection in order to propagate the email. The time it takes for the SMTP server to deliver the email to the recipients is not included, as these operations can be done asynchronously and do not require the mobile client to remain connected. Similarly, for CoFi runs only the time it takes to transmit the emails between the CoFi local and remote proxies is measured, and neither the time needed to compose and send emails to third-party email recipients, nor the time it takes for CoFi-enabled recipients to read the email adaptively is included.

Full 710 demonstrates that the CoFi overhead is small, averaging less than 5% over all emails. In contrast, Partial 720 shows that progressive propagation of the attachments reduces the latency by roughly 80%. The 5% overhead in CoFi corresponds to the cost involved in parsing the email content to find its structure, exchanging the control information, and transcoding the images.

### Experimental Results: Outlook—Fidelity Upgrade

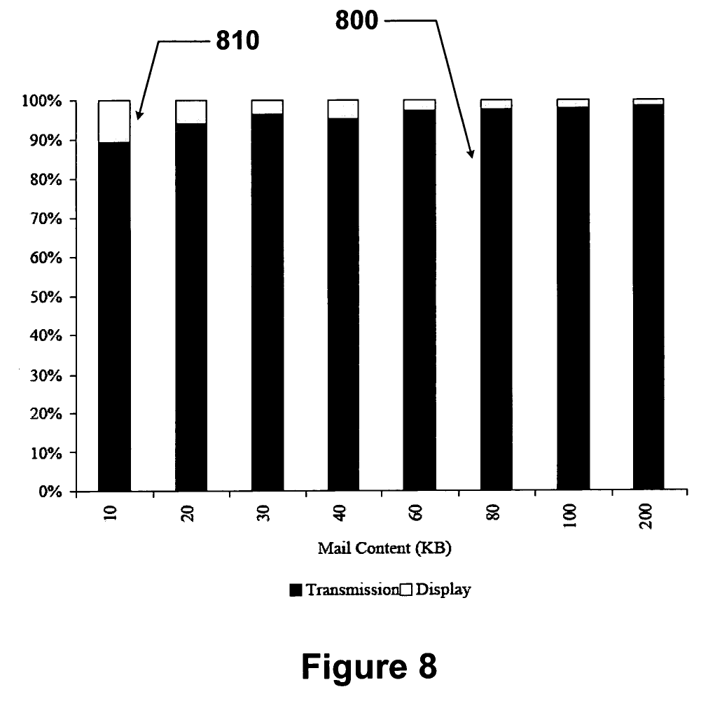

The time it takes for a CoFi-enabled recipient to upgrade a partial-fidelity image to full fidelity was measured. FIG. 8 shows that the largest fraction of the time necessary for this fidelity upgrade is due to transmission (Transmission) 800, and that only a small fraction of the time is spent on displaying the upgraded images in the application (Display) 810. In other words, the overhead caused by CoFi's use of the API is very small. While the overhead was not expected to be significant, these results confirm that CoFi supports these kinds of adaptations in practice.

### Experimental Results: PowerPoint

PowerPoint was adapted to support adaptation-aware editing and progressive update propagation. Adaptation-aware editing reduces download time by enabling mobile clients to edit PowerPoint presentations that have been aggressively adapted. Note that loading text-only versions of PowerPoint presentations may reduce download latency over bandwidth-limited links by over 90% for large presentations. Below, the benefits of progressive update propagation are evaluated, the latency for updating a PowerPoint presentation with higher-fidelity data are quantified, and the conflict resolution policy is discussed.

### Experimental Results: PowerPoint—Progressive Update Propagation

CoFi-enabled PowerPoint propagates modifications progressively by saving back just subsets of the modified slides or embedded objects, or by transcoding embedded images into a progressive JPEG representation and saving just portions of the images' data. An adaptation policy that propagates modifications every time the user saves the document was implemented. The policy propagates the text content of any new or modified slides and transcoded versions of new or modified embedded images. Image fidelity refinements are then propagated on every subsequent save request until all images at the CoFi remote proxy reach full fidelity.

The effectiveness of progressive update propagation was evaluated by measuring the latency for saving modifications to a set of synthetic PowerPoint documents. Synthetic documents were constructed by replicating a single slide that contained 4 KB of text and a 80 KB image.

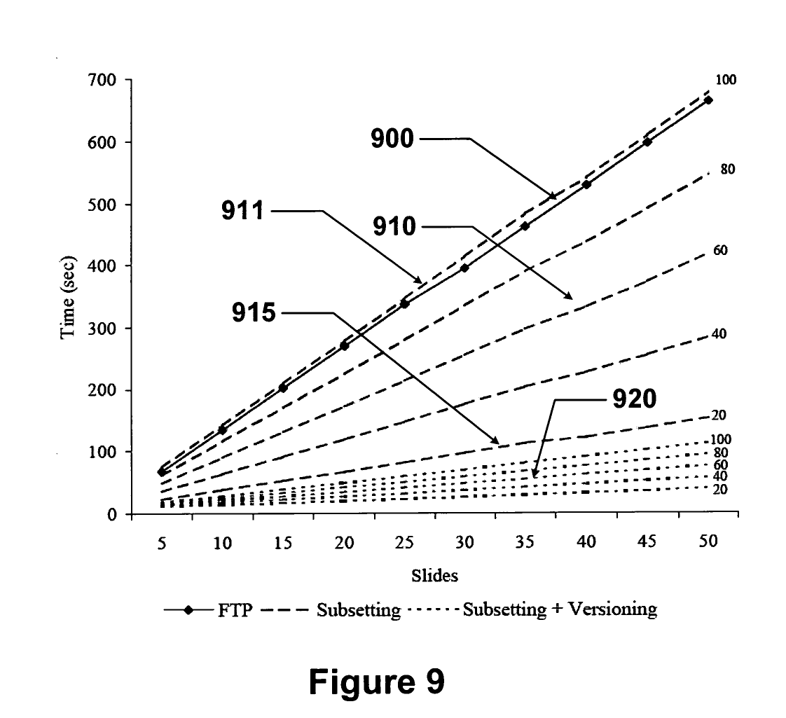

FIG. 9 shows latency measurements for saving PowerPoint documents with up to 50 slides over a 56 Kb/sec network link. The figure shows latency results 900 for transferring the documents over FTP and adaptation policies that use subsetting and versioning to reduce the data traffic. The FTP measurements 900 give a baseline for the time it takes to transfer the full document without any adaptation. This baseline is used to determine the effectiveness of the adaptation policies.

FIG. 9 also plots the results of 5 experiments that use subsetting 910 to reduce latency. The numbers on the right hand side of the plot, next to each line, show the proportion of document slides that was saved back to the remote proxy. In this manner, the topmost line 911 corresponds to documents that were saved in their entirety, while the lowest subsetting line 915 corresponds to documents where only modifications to 20% of the slides were saved. In all experiments, both the slide's text and single image were assumed to have been modified and so had to be saved back. The topmost subsetting line 911, which corresponds to saving the full document, shows that the CoFi overhead is small, averaging less than 5% over all documents. In contrast, all other subsetting experiments 910 show significant reductions in upload latency. The lowest five lines 920 in FIG. 9 show the results for an adaptation policy that uses subsetting and versioning of images to further reduce upload latency. This policy converts images embedded in slides into a progressive JPEG representation and transfers only the initial 1/7 of the image's data, achieving even larger reductions in upload latency.

### Experimental Results: PowerPoint—Fidelity Upgrade

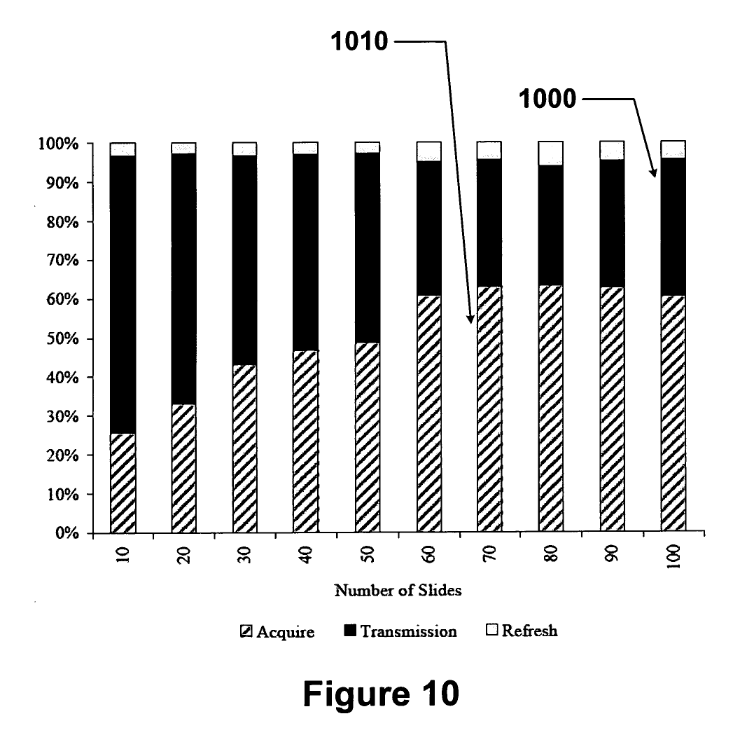

FIG. 10 shows the breakdown of the execution time for updating a single image with higher fidelity data. FIG. 10 shows that the API calls to replace the image (Display) 1000 account for a small portion of the overall latency, similar to what was seen for Outlook in FIG. 8. More significantly, FIG. 10 shows that for large documents, roughly 60% of the time for upgrading the fidelity of an image is spent making sure the user did not modify the image that is about to be updated (Detect) 1010. Detecting modifications is time-consuming because PowerPoint's API does not support querying whether a component has been changed. Instead, modifications were detected by saving a temporary copy of the presentation on disk, parsing this copy, and comparing it with the local proxy copy of the presentation. Writing out a copy of the presentation to disk dominates the cost of all other factors in the total time taken for detecting modifications.

This experiment represents a worst-case scenario of having to write out the entire document to upgrade a single image. Under normal operation, modification detection is expected to benefit from PowerPoint's ability to write out modifications incrementally, as well as from the possible batching of multiple component upgrades into a single operation (i.e., updating a set of images at a time). Detecting modification is also only necessary if editing of partial-fidelity images is allowed. If editing partial-fidelity images is not allowed, then the cost to upgrade an image is just a few milliseconds over the time it takes to transmit the image over the bandwidth-limited link.

In any case, the large modification detection time results from specific limitations of the current PowerPoint API (which could be easily fixed by adding an API call for checking if a component has been changed), and is not a fundamental limitation of either adaptation-aware editing or progressive update propagation.

### Experimental Results: PowerPoint—Conflict Resolution

The following conflicts are considered: one user modifies a slide while another user deletes it, two users move a slide to different positions in the presentation, or two users concurrently modify the same slide. These conflicts are referred to as edit-delete, move-move, and edit-edit, respectively. For simplicity, for the rest of this section, the copy of the presentation available at the remote and local proxies is referred to as the remote and local copies, respectively.

The PowerPoint policy resolves edit-delete and move-move conflicts automatically. For edit-delete conflicts, the policy prioritizes editing over deletion, recreating the slide in the replica where it was deleted. For move-move conflicts, the policy gives priority to the local copy, moving the slide in the remote copy to reflect its position in the local copy. Finally, edit-edit conflicts are resolved by using the CoFi PowerPoint driver to present the two conflicting slides to the user, and prompting the user to resolve the conflict by either choosing one of the slides or by merging their content. The above policy is, however, just one of the possible ways to resolve conflicts, and many variations and/or extensions to this simple policy may be envisioned by those of ordinary skill in the art having the benefit of the present disclosure.

The cost of conflict detection is highly dependent on the size of the documents. The bulk of the cost stems from writing out the document, as described above in the section on Experimental Results: PowerPoint—Fidelity Upgrade, and from transmitting the data over the network. All other aspects, including the execution of the conflict detection algorithm and the use of the APIs to display conflicts to the user, are insignificant.

The present disclosure is believed to be the first to introduce mechanisms that support propagating partial-fidelity versions of modifications, as well as their progressive improvement. For example, CoFi is a system that is aware of the fidelity level of the objects that are replicated. Moreover, CoFi is believed to be the first to provide adaptation support for multimedia authoring and collaborative work over bandwidth-limited devices. Furthermore, CoFi allows the propagation of partial-fidelity versions of modifications. CoFi also implements an optimistic primary replica replication model as described in the section above on Combining Adaptation-Aware Editing and Progressive Update Propagation: Optimistic Replication.

Adaptation-aware editing and progressive update propagation have been described herein, two novel mechanisms for supporting multimedia authoring and collaborative work on bandwidth-limited devices. Both mechanisms decompose documents into their components structures (e.g., pages, images, paragraphs, sounds) and keep track of consistency and fidelity at a component granularity. Adaptation-aware editing lowers download latencies by enabling users to edit adapted documents. Progressive update propagation shortens the propagation time of components created or modified at the bandwidth-limited device by transmitting subsets of the modified components or transcoded versions of the modifications.

Support for adaptation-aware editing and progressive update propagation can be added to optimistic and pessimistic replication protocols in an orthogonal fashion, as has been demonstrated herein. Specifically, new states may be added to the state machines that describe the replication protocols, but the existing states and transitions may remain unaffected.

The implementation of a CoFi prototype has been described, which supports adaptation-aware editing and progressive update propagation for optimistic client-server replication. Performance results for experiments with multimedia authoring and collaboration with two real world applications have been presented. For these applications, the ability to edit partially loaded documents and progressively propagate fidelity refinements of modifications substantially reduce upload and download latencies.

While the experiments described herein focus on document-centric applications, the same principles can be extended to applications with real-time requirements, such as video and/or audio. Adaptation-aware editing could be used to support video editing, while progressive update propagation would be useful in situations where there is a benefit in retransmitting a higher-fidelity version of a video and/or an audio stream, such as when a user listens to a recording multiple times.

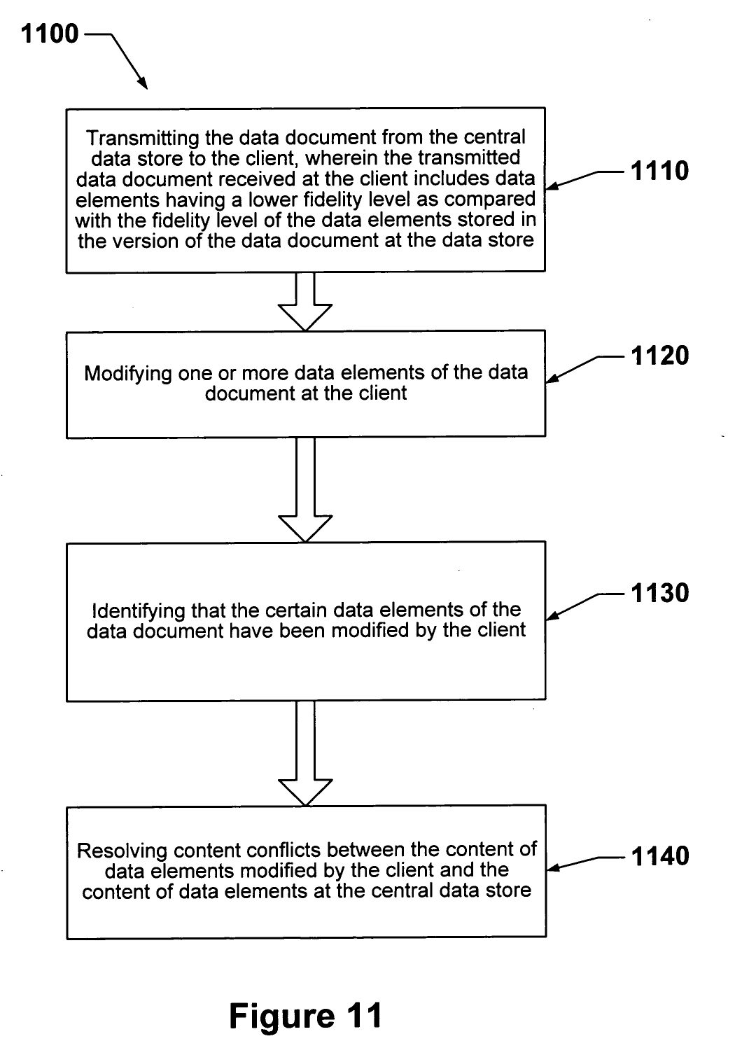

In various illustrative embodiments, as shown in FIG. 11, a method 1100 for the exchange of a data document between a central data store and a client, the data document including one or more data elements, may be provided. The method 1100 may comprise transmitting the data document from the central data store to the client, wherein the transmitted data document received at the client includes data elements having a lower fidelity level as compared with the fidelity level of the data elements stored in the version of the data document at the data store, as indicated at 1110, and modifying one or more data elements of the data document at the client, as indicated at 1120. The method 1100 may also comprise identifying that the certain data elements of the data document have been modified by the client, as indicated at 1130, and resolving content conflicts between the content of data elements modified by the client and the content of data elements at the central data store, as indicated at 1140.

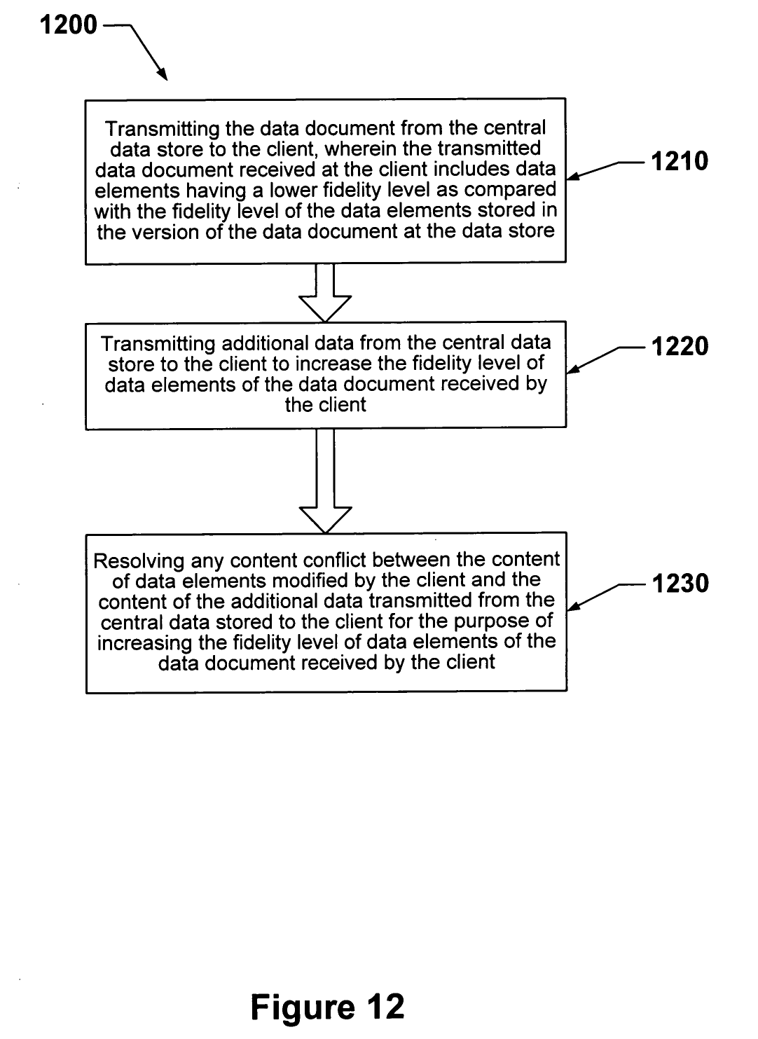

In various alternative illustrative embodiments, as shown in FIG. 12, a method 1200 for the exchange of a data document between a central data store and a client, the data document including one or more data elements, may be provided. The method 1200 may comprise transmitting the data document from the central data store to the client, wherein the transmitted data document received at the client includes data elements having a lower fidelity level as compared with the fidelity level of the data elements stored in the version of the data document at the data store, as indicated at 1210. The method 1200 may also comprise transmitting additional data from the central data store to the client to increase the fidelity level of data elements of the data document received by the client, as indicated at 1220, and resolving any content conflict between the content of data elements modified by the client and the content of the additional data transmitted from the central data stored to the client for the purpose of increasing the fidelity level of data elements of the data document received by the client, as indicated at 1230.

The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. In particular, every range of values (of the form, “from about a to about b,” or, equivalently, “from approximately a to b,” or, equivalently, “from approximately a-b”) disclosed herein is to be understood as referring to the power set (the set of all subsets) of the respective range of values, in the sense of Georg Cantor. Accordingly, the protection sought herein is as set forth in the claims below.

Therefore, the present invention is well adapted to attain the ends and advantages mentioned as well as those that are inherent therein. While numerous changes may be made by those skilled in the art, such changes are encompassed within the spirit of this present invention as defined by the appended claims.

What is claimed is:

1. A method for the exchange of a data document between a central data store and a client, the data document including one or more data elements, the method comprising:
transmitting the data document from the central data store to the client, wherein the transmitted data document received at the client includes data elements having a lower fidelity level as compared with the fidelity level of the data elements stored in the version of the data document at the data store;
modifying one or more data elements of the data document at the client;
identifying that the certain data elements of the data document have been modified by the client; and
resolving content conflicts between the content of data elements modified by the client and the content of data elements at the central data store.

2. A method for the exchange of a data document between a central data store and a client, the data document including one or more data elements, the method comprising:
transmitting the data document from the central data store to the client, wherein the transmitted data document received at the client includes data elements having a lower fidelity level as compared with the fidelity level of the data elements stored in the version of the data document at the data store;
transmitting additional data from the central data store to the client to increase the fidelity level of data elements of the data document received by the clients; and
resolving any content conflict between the content of data elements modified by the client and the content of the additional data transmitted from the central data stored to the client for the purpose of increasing the fidelity level of data elements of the data document received by the client.
